(19) United States
(12) Patent Application Publication
(10) Pub. No.: US 2004/0091679 A1
(43) Pub. Date: May 13, 2004

(54) Printing media, apparatus and method

(76) Inventors: Matthias D. Kemeny, Vancouver, WA (US); Tony Wheeler, Signal Mountain, TN (US)

Correspondence Address: KOLISCH HARTWELL, P.C., 520 S.W. YAMHILL STREET, SUITE 200, PORTLAND, OR, 97204, US

(21) Appl. No.: 10/436,923

(22) Filed: May 12, 2003

Related U.S. Application Data
(60) Provisional application No. 60/379,647, filed on May 10, 2002.

(51) Int. Cl. B32B 1/00

(52) U.S. Cl. 428/195.1

(57) ABSTRACT

A printing medium configured to receive a printing fluid to form a printed graphic is disclosed. The printing medium comprises a support layer, and a printable layer disposed on the support layer. The printable layer is configured to receive and retain the printing fluid, and includes a plurality of polymer beads dispersed in a binder.

### CROSS-REFERENCE TO RELATED APPLICATION

This application claims priority from U.S. Provisional Patent Application Serial No. 60/379,647, filed May 10, 2002, which is hereby incorporated by reference.

### TECHNICAL FIELD

The present invention relates to printing media including a printable layer having a plurality of polymer beads that is selectively curable to form a transferable graphic, and also to methods and apparatuses for printing graphics onto a printing medium.

### BACKGROUND

Many projects in the advertising, trade show, and other related industries require the manufacture of relatively large-scale signs and displays. These displays are typically manufactured using a vinyl transfer process. A vinyl transfer process generally begins with the use of a vinyl starting material sheet having a vinyl film removably attached to a release sheet with an adhesive. These sheets are sold in rolls, and each roll has a single color. Thus, multiple rolls of the sheets must be kept in inventory if it is desired to have a broad color selection close at hand.

The display graphics are formed by cutting into the starting material sheet to separate the graphics from background material. The cut typically extends through the vinyl film and the adhesive, but not the release sheet. Next, the background material is removed via a process called “weeding.” The weeding process leaves only the vinyl that defines the graphics on the release sheet. The process of weeding may be slow and labor intensive, and may waste much starting material. After weeding, the graphics are transferred from the release sheet onto a transfer sheet, from which they may be transferred to a display or sign.

The many individual steps of typical vinyl transfer processes may consume large amounts of time and raw materials. Thus, these processes may be less-than-ideal solutions to the problem of graphics transfer in the display, advertising and sign industries.

### SUMMARY

One aspect of the present invention provides a printing medium configured to receive a printing fluid to form a printed graphic. The printing medium comprises a support layer, and a printable layer disposed on the support layer. The printable layer is configured to receive and retain the printing fluid, and includes a plurality of polymer beads dispersed in a binder.

Another aspect of the present invention provides a method of printing graphics onto a printing medium for transfer to a display medium, wherein the printing medium includes a printable layer disposed on a support layer, and wherein the printable layer includes a plurality of polymer beads dispersed in a binder, and wherein the printable layer also includes a concentration of a curable component. The method comprises printing a coloring agent onto the printable layer of the printing medium in selected locations of the printable layer to form a printed graphic, printing a curing initiator onto the printable layer in the selected locations of the printable layer, and activating the curing initiator to cure the selected locations of printable layer to cure the printed graphic.

Yet another aspect of the present invention provides a printhead for printing a printing fluid onto a printing medium, the printing fluid including at least one of a coloring agent and a curing initiator. The printhead comprises a printing fluid ejection mechanism configured to transfer the printing fluid onto the printing medium, and an energy source configured to activate the curing initiator, wherein the energy source is configured to emit at least one of thermal and electromagnetic energy, and wherein the energy source is positioned relative to the printing fluid ejection mechanism such that the energy source follows the printing fluid ejection mechanism across the printing medium and cures the portions of the printing medium onto which the printing fluid was previously applied.

### BRIEF DESCRIPTION OF THE DRAWINGS

FIG. 1 is an isometric view of a printing medium according to a first embodiment of the present invention.

FIG. 2 is a sectional view of the embodiment of FIG. 1, taken along line 2-2 of FIG. 1.

FIG. 3 is a magnified sectional view of the area defined by line 3 of FIG. 2.

FIG. 4 is an isometric view of a printhead in the process of printing graphics onto the embodiment of FIG. 1.

FIG. 5 is a schematic depiction of the printhead of FIG. 4.

FIG. 6 is an isometric view depicting the application of the graphics of FIG. 4 to a display medium.

FIG. 7 is an isometric view depicting the release of the graphics of FIG. 4 from the embodiment of FIG. 1.

FIG. 8 is a sectional view of a second embodiment of a printing medium according to the present invention.

FIG. 9 is a sectional view of a third embodiment of a printing medium according to the present invention.

FIG. 10 is a schematic depiction of a printhead suitable for printing onto the embodiments of FIGS. 8-9.

### DETAILED DESCRIPTION OF THE DEPICTED EMBODIMENTS

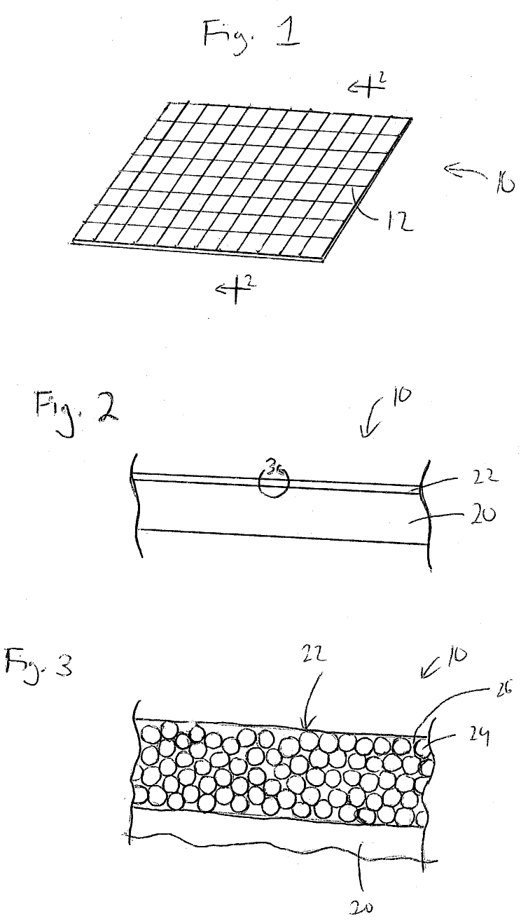

A first embodiment of a printing medium according to the present invention is depicted generally at 10 in FIG. 1. Printing medium 10 may have a generally thin, flat shape suitable for feeding through a printing device. Also, printing medium 10 may be opaque, but is more typically at least partially translucent or transparent to allow printing medium 10 to be more easily located in a desired position over a display medium for the transfer of graphics.

Printing medium 10 may include a positional reference marker, such as a plurality of lines 12, to aid the alignment of the printing medium over the display medium. The depicted lines are arranged in a grid-like pattern, but it will be appreciated that the lines may have any other desired arrangement or appearance. Furthermore, it will be appreciated that any other suitable visual location aid besides lines may be used. Examples include, but are not limited to, one or more dots or other similar marks.

FIG. 2 shows a sectional view of printing medium 10. Printing medium 10 includes a support layer 20 and a printable layer 22. Support layer 20 may be made of a translucent or transparent material that allows a display medium to be viewed through printing medium 10 while the printing medium is positioned over the display medium. Alternately, support layer may be made of an opaque material. Support layer 20 may also be configured to be feedable through a selected printing device.

Support layer 20 is typically formed from a flexible material, such as a suitable polymeric material, but may also be formed of a rigid or semi-rigid material, such as a suitable glass, depending upon the requirements of the selected printing device. Lines 12 may be formed on support layer 20, rather than on printable layer 22, so that they are not transferred to a display medium along with the graphics.

Printable layer 22 is configured to receive a printing fluid containing a coloring agent (described in more detail below) to form graphics on printing medium 10. Printable layer 22 may also be configured to be polymerizable to improve the integrity of graphics printed on printing medium 10, and thus to improve the resistance of the graphics to damage during transfer to a display medium.

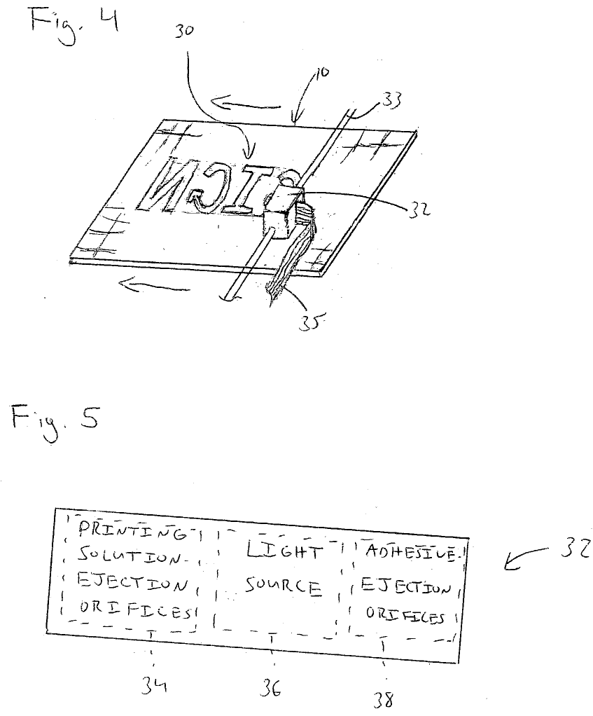

FIG. 3 shows printable layer 22 in more detail. Printable layer 22 includes a plurality of polymer beads 24, and a binder 26 disposed between the beads 24 to hold printable layer 22 together, and to hold printable layer 22 to support layer 20. Polymer beads 24 may be made of any suitable polymer. Examples of suitable polymers include, but are not limited to, divinyl benzene, and acrylic and methacrylic polymers. Polymer beads 24 may also have any suitable size. Examples of suitable sizes include, but are not limited to, diameters between approximately two and one hundred microns. Binder 26 may be made of any suitable material. Examples of suitable materials include, but are not limited to, acrylic acid and other acrylates.

Polymer beads 24 are typically provided in a sufficiently high concentration in printable layer 22 for each polymer bead to be in contact with at least some adjacent polymer beads. Also, each polymer bead 24 typically contains a quantity of unreacted monomer, dimer, oligomer, etc., or another suitable cross-linking agent. This allows adjacent beads to be joined together via a polymerization reaction with the addition of a suitable initiator, as explained in more detail below. Likewise, the binder may also contain additional concentrations of such materials to further aid in curing printed graphics.

FIG. 4 shows an example of the printing of graphics 30 (in the form of the word “sign”) onto printing medium 10 via a fluid ejection printhead 32. Lines 12 have been omitted from the central portion of printing medium 10 for clarity. Graphics 30 may be printed onto printing medium 10 either in a backward orientation, as shown in FIG. 4, or in a forward orientation, depending upon the transfer process to be used to transfer the graphics onto a display medium. Graphics 30 are more typically printed onto printing medium 10 in a backward orientation, as this allows the graphics to be applied directly to a display medium without the use of an intermediate transfer sheet.

The depicted printhead 32 moves across printing medium 10 on a rail 33, and typically includes a plurality of conduits 35 through which a printing fluid and an adhesive (described in more detail below) may be supplied to the printhead. Printing to facilitate cross-linking between polymer beads, and other components commonly used in inks.

Any suitable initiator may be used in the printing fluid to initiate the polymerization of polymer beads 24 to one another. Examples include, but are not limited to, thermal initiators and photoinitiators. Thermal initiators are activated by thermal energy, while photoinitiators are activated by exposure to electromagnetic energy of a suitable wavelength. Suitable photoinitiators include, but are not limited to, those that are activated by energy in the near-UV, violet and/or blue regions.

Where a photoinitiator is used to initiate polymerization of polymer beads 24 to one another, printhead 32 may include an electromagnetic energy source configured to activate the initiator. A schematic depiction of an exemplary printhead 32 having an electromagnetic energy source for activating a photoinitiator is shown in FIG. 5. Printhead 32 includes one or more printing fluid ejection orifices 34, an electromagnetic energy source 36, and one or more adhesive ejection orifices 38. These components are arranged on printhead 32 such that printing fluid ejection orifices 34 pass over printing medium 30 first, followed by electromagnetic energy source 34, and then adhesive ejection orifices 36. It will be appreciated that the adhesive may be applied in a later step by a separate apparatus. In this embodiment, printhead 32 may not include adhesive ejection orifices 38. Likewise, it will be appreciated that printhead 32 may include a thermal energy source either in place of, or in addition to, the electromagnetic energy source where a thermal initiator is used.

Printing fluid ejection orifices 34 are configured to transfer printing fluid onto printing medium 10. Printing fluid ejection orifices 34 may be configured to be used with only a single color (or black) printing fluid, or may be configured to be used with multiple colored printing fluids to permit the creation of color graphics on printing medium 10. Printing fluid ejection orifices may eject printing fluid in any suitable manner, including but not limited to, continuous drop mechanisms, and thermal and piezoelectric selective drop mechanisms.

Electromagnetic energy source 36 is positioned on printhead 32 such that it trails printing fluid ejection orifices 34 across printing medium 10. In this configuration, electromagnetic energy source 36 illuminates the printing fluid just after the printing fluid is deposited onto printing medium 10, thus activating the initiator. Electromagnetic energy source 36 may be configured to illuminate printing medium 10 only where printing fluid is deposited on the printing medium via a selective on/off mechanism, or may be configured to emit electromagnetic energy continuously. Furthermore, electromagnetic energy source 36 may be configured to emit electromagnetic energy any suitable portion of the electromagnetic spectrum. Examples include, but are not limited to, wavelengths in the visible and near-UV spectrum.

Any suitable electromagnetic energy-emitting device may be used as electromagnetic energy source 36. Examples of suitable electromagnetic energy sources include, but are not limited to, light emitting diodes (LEDs), diode lasers (or other lasers), and incandescent and fluorescent lamps. The use of LEDs and/or diode lasers may offer advantages over other devices, as these devices may emit energy at a higher luminous intensity at a selected level of power consumption. Where a high luminous intensity is desired, electromagnetic energy source 36 may include more than one LED, diode laser and/or lamp.

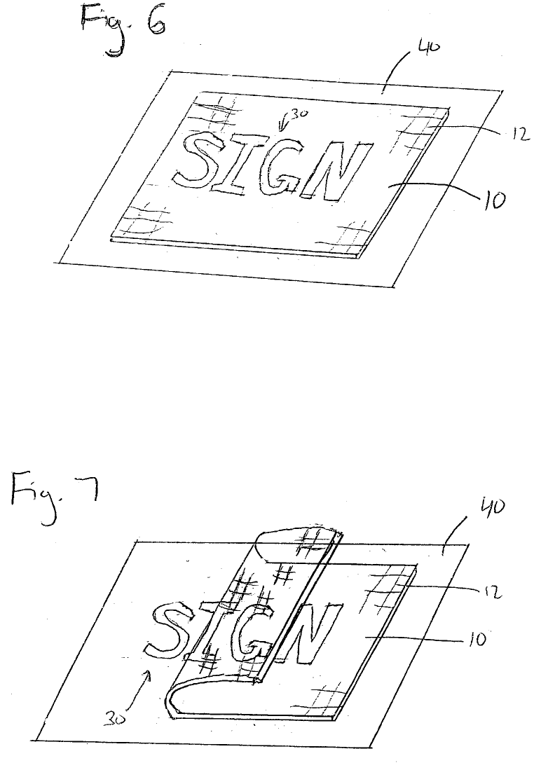

Adhesive ejection orifices 38 are configured to follow electromagnetic energy source 36 across printing medium 10, and to deposit a layer of an adhesive 38 over the portions of printing medium 10 onto which the printing fluid was previously applied. In this manner, only portions of printing medium 10 that were previously colored and cured are coated with the adhesive. This allows graphics 30 to be applied to a display medium in a very simple manner, described below and illustrated in FIGS. 6-7. While printing fluid ejection orifices 34, electromagnetic energy source 36 and adhesive ejection orifices 38 are shown as positioned on a single printhead 32, it will be appreciated that the printing fluid ejection orifices, electromagnetic energy source and adhesive ejection orifices may also be provided as separate components without departing from the scope of the present invention. Furthermore, while the adhesive ejection orifices of the depicted embodiment are configured to trail behind the electromagnetic energy source, it will be appreciated that the adhesive ejection orifices may also be positioned next to the printing fluid ejection orifices, and thus lead the electromagnetic energy source across the page. This may enable the use of an adhesive that is cured by electromagnetic energy of the frequency emitted by the depicted electromagnetic source.

FIGS. 6 and 7 depict the process of transferring graphics 30 from printing medium 10 onto a display medium 40. First referring to FIG. 6, printing medium 10 is inverted and pressed against the display medium 40. The translucent or transparent nature of printing medium 10 allows the position of graphics 30 on display medium 40 to be easily determined, and lines 12 on the printing medium further help in the positioning of the graphics on the display medium.

Because the adhesive is applied only to those portions of printing medium 10 that form graphics 30, only the graphics adhere to the display medium. Furthermore, because only those portions of printable layer 22 that form graphics 30 are polymerized or otherwise cured, the graphics separate easily from the rest of printable layer 22. Therefore, as shown in FIG. 7, when printing medium 10 is peeled off of display medium 40, graphics 30 remains on display medium 40. In this manner, graphics are transferred to display medium 40 without the use of an intermediate transfer sheet, or any time-consuming intermediate transfer steps.

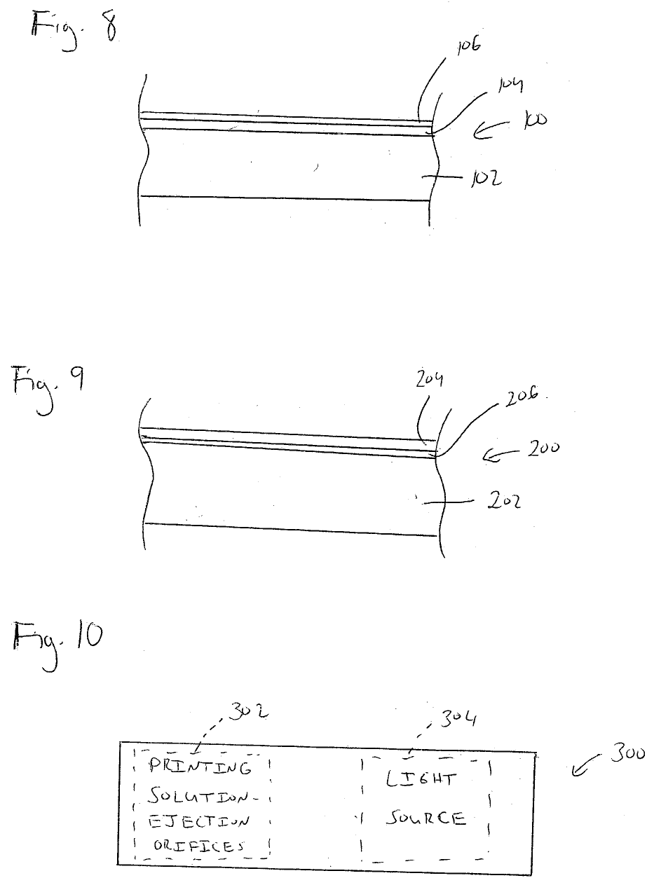

FIG. 8 shows, generally at 100, a sectional view of a second embodiment of a printing medium according to the present invention. Printing medium 100 includes a support layer 102, and a printable layer 104 disposed on top of support layer 102.

Support layer 102 may have any of the properties described above for support layer 20. For example, support layer 102 may be made of a translucent or transparent material to allow graphics printed on printing medium 100 to be more easily transferred to a display medium, and may be made from either a flexible or a rigid material.

Similarly, printable layer 104 may have any of the properties described above for printable layer 22. For example, printable layer 104 may include a plurality of polymer beads that may be selectively colored and polymerized to form graphics, and may also include a binder to hold the beads together. The printable layer 104 may also be at least partially translucent or transparent, and may be configured to receive a coloring agent applied by a fluid ejection printing device.

In addition to support layer 102 and printable layer 104, printing medium 100 also includes an adhesive layer 106 disposed on top of the printable layer. Adhesive layer 106 is typically formed from an adhesive that is activated by exposure to a suitable form of energy, such as thermal energy or electromagnetic energy. In some embodiments of the invention, adhesive layer 106 is activated by electromagnetic energy of the same or a similar frequency as the photoinitiator contained within the printing fluid. Thus, in these embodiments, both the adhesive in adhesive layer 106 and the initiator in printable layer 104 may be activated by a single illumination with an electromagnetic energy source.

FIG. 9 shows a sectional view of a third embodiment of a printing medium according to the present invention, generally at 200. Printing medium 200 is similar in many aspects to printing medium 100. For example, printing medium 200 includes a support layer 202, a printable layer 204, and an adhesive layer 206. Adhesive layer 206 is configured to be activated by exposure to a suitable form of energy, for example, thermal or electromagnetic energy. However, adhesive layer 206 is disposed between printable layer 204 and support layer 202. Thus, in this embodiment, it may be desirable to use an adhesive that releases easily from a selected support layer 202 so that graphics release easily from support layer 202 for transfer to a display medium.

FIG. 10 shows, generally at 300, a schematic depiction of a printhead suitable for printing onto either of printing media 100 or 200. Printhead 300 typically includes one or more printing fluid ejection orifices 302 for depositing printing fluid onto printing media 100 or 200, and an electromagnetic energy source 304 configured to produce or emit energy of a wavelength suitable for curing the adhesive in adhesive layers 106 or 206. Because the adhesive is provided in adhesive layers 106 or 206, it is not necessary to apply an adhesive to printable layers 104 or 204 after applying the printing fluid. Thus, printhead 300 does not need to have the capability to apply an adhesive. Once the adhesive has been activated by electromagnetic energy source 304, the graphics printed on printing medium 100 may be applied directly to a display medium for transfer in the manner shown in FIGS. 6-7. Graphics printed on printing medium 200, however, may have to be applied to a display medium with an intermediate transfer sheet, due to the location of adhesive layer 206 between printable layer 204 and support layer 202.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A printing medium configured to receive a printing fluid to form a printed graphic, the printing medium comprising:
a support layer; and
a printable layer disposed on the support layer and configured to receive and retain the printing fluid, wherein the printable layer includes a plurality of polymer beads dispersed in a binder.

2. The printing medium of claim 1, wherein the support layer is at least partially translucent.

3. The printing medium of claim 2, wherein the support layer is transparent.

4. The printing medium of claim 2, wherein the support layer includes at least one positional reference marker configured to be aligned with a feature on a display medium to facilitate transfer of the printed graphic to the display medium.

5. The printing medium of claim 4, wherein the positional reference marker includes a plurality of lines arranged in a grid-like pattern.

6. The printing medium of claim 1, wherein the support layer is opaque.

7. The printing medium of claim 1, wherein the support layer is made of a flexible material.

8. The printing medium of claim 1, wherein the support layer is made of a substantially rigid material.

9. The printing medium of claim 1, wherein the support layer is made of a glass material.

10. The printing medium of claim 1, wherein the printable layer includes a concentration of a material selected from the group consisting of a monomer, dimer, oligomer and cross-linking agent.

11. The printing medium of claim 1, wherein the printing fluid contains an initiator configured to initiate a reaction of the monomer, dimer, oligomer and/or cross-linking agent to cure portions of the printable layer exposed to the printing fluid.

12. The printing medium of claim 1, wherein the initiator is selected from the group consisting of photoinitiators and thermal initiators.

13. The printing medium of claim 1, wherein the polymer beads are made of a material selected from the group consisting of divinyl benzene, and acrylic and methacrylic polymers.

14. The printing medium of claim 1, wherein the polymer beads have an average diameter of between approximately two and one hundred microns.

15. The printing medium of claim 1, wherein the binder is at least partially made of a material selected from the group consisting of acrylic acid and acrylates.

16. The printing medium of claim 1, further comprising an adhesive layer disposed over the printable layer, wherein the adhesive layer is configured to facilitate the adherence of a printed graphic to a surface when the graphic is transferred to the surface.

17. The printing medium of claim 16, wherein the adhesive layer includes an adhesive material that is cured by exposure to at least one of thermal and electromagnetic energy.

18. The printing medium of claim 17, wherein the adhesive material is curable by exposure to electromagnetic energy of substantially the same frequency as electromagnetic energy that activates a photoinitiator used to cure the binder.

19. The printing medium of claim 1, further comprising an adhesive layer disposed between the printable layer and the support layer.

20. A method of printing graphics onto a printing medium for transfer to a display medium, the printing medium including a printable layer disposed on a support layer, the printable layer including plurality of polymer beads dispersed in a binder, the printable layer also having a concentration of a curable component, the method comprising:
printing a coloring agent onto the printable layer of the printing medium in selected locations of the printable layer to form a printed graphic;
printing a curing initiator onto the printable layer in the selected locations of the printable layer; and
activating the curing initiator to cure the selected locations of printable layer to cure the printed graphic.

21. The method of claim 20, wherein the coloring agent and the curing initiator are printed simultaneously.

22. The method of claim 20, wherein the coloring agent and the curing initiator are contained within a single printing fluid.

23. The method of claim 20, wherein the curing initiator is activated by exposure to at least one of thermal energy and electromagnetic energy.

24. The method of claim 20, wherein the curing initiator is activated by an electromagnetic energy source selected from the group consisting of a diode laser, a light emitting diode, and a lamp.

25. The method of claim 20, further comprising transferring the printed graphic to a display medium after curing the printed graphic.

26. The method of claim 25, wherein transferring the printed graphic includes adhering the printed graphic to the display medium with an adhesive.

27. The method of claim 25, wherein the adhesive is added to the printed graphic after the printed graphic is cured.

28. The method of claim 25, wherein the adhesive is added to the printing medium before the printing of the coloring agent and initiator.

29. The method of claim 25, wherein transferring the printing graphic to a display medium includes placing the printable layer of the printing medium against the display medium, and then removing the support layer and uncured portions of the printing medium to leave the cured graphic on the display medium.

30. The method of claim 29, wherein the printing medium is at least partially transparent and includes a positional reference marker, further comprising aligning the printed graphic with the display medium via the positional reference marker.

31. The method of claim 25, wherein the positional reference marker includes a plurality of lines arranged in a grid-like pattern on the support layer.

32. A printhead for printing a printing fluid onto a printing medium, the printing fluid including at least one of a coloring agent and a curing initiator, the printhead comprising:
a printing fluid ejection mechanism configured to transfer the printing fluid onto the printing medium; and
an energy source configured to activate the curing initiator, wherein the energy source is configured to emit at least one of thermal and electromagnetic energy, and wherein the energy source is positioned relative to the printing fluid ejection mechanism such that the energy source follows the printing fluid ejection mechanism across the printing medium and cures the portions of printing medium onto which the printing fluid was previously applied.

33. The printhead of claim 32, wherein the printhead is a fluid ejection printhead having separate coloring agent ejection orifices and initiator ejection orifices.

34. The printhead of claim 32, wherein the coloring agent and curing initiator are included together in the printing fluid and are ejected from a single set of fluid ejection orifices.

35. The printhead of claim 32, further comprising an adhesive ejection mechanism configured to transfer an adhesive onto the printing medium after transferring the printing fluid onto the printing medium.

36. The printhead of claim 32, wherein the energy source is configured to continuously emit energy.

37. The printhead of claim 32, wherein the energy source is configured to emit energy only over portions of the printing medium that have previously received printing fluid.

38. The printhead of claim 32, wherein the energy source includes at least one of a laser diode, a light emitting diode, and a lamp.
